(19) United States
(12) Patent Application Publication
(10) Pub. No.: US 2026/0050856 A1
(43) Pub. Date: Feb. 19, 2026

(54) METHOD AND SYSTEM OF PREDICTING ENERGY CONSUMPTION AND RECOMMENDING METHOD OF INSTALLING ENERGY CONSUMPTION MEASURING DEVICE

(71) Applicant: INSTITUTE FOR INFORMATION INDUSTRY, Taipei City (TW)

(72) Inventors: Cheng Juei YU, Taipei City (TW); Yin Jing TIEN, Taipei City (TW); Tsung Chen HSIEH, Taipei City (TW); An Sheng SHEU, Taipei City (TW)

(73) Assignee: INSTITUTE FOR INFORMATION INDUSTRY, Taipei City (TW)

(21) Appl. No.: 18/918,847

(22) Filed: Oct. 17, 2024

(30) Foreign Application Priority Data
Aug. 14, 2024 (TW) 113130493

(51) Int. Cl. G06Q 10/0639; G06Q 10/04

(52) U.S. Cl. CPC G06Q 10/0639; G06Q 10/04

(57) ABSTRACT

A method of predicting energy consumption, performed by a computing device, includes: obtaining historical manufacturing data, wherein each piece of historical manufacturing data includes total energy consumption and historical performance values corresponding to manufacturing conditions, respectively, each of manufacturing conditions includes at least one of an equipment type and a product type, and each of historical performance value indicates at least one of an equipment operation duration and a product quantity; training and generating unit energy consumption prediction model using the historical manufacturing data; obtaining at least one piece of unit energy consumption of at least one manufacturing conditions using default performance values corresponding to manufacturing conditions and unit energy consumption prediction model; and outputting at least one piece of unit energy consumption. The present disclosure further provides a system of predicting energy consumption and recommending method of installing energy consumption measuring device.

### CROSS-REFERENCE TO RELATED APPLICATIONS

This non-provisional application claims priority under 35 U.S.C. § 119(a) on Patent Application No(s). 113130493 filed in Republic of China (ROC) on Aug. 14, 2024, the entire contents of which are hereby incorporated by reference.

### BACKGROUND

### 1. Technical Field

This disclosure relates to a method and system of predicting energy consumption and recommending method of installing energy consumption measuring device.

### 2. Related Art

To comply with international green supply chain requirements, international carbon regulations, and to facilitate in the transformation of the manufacturing industry, it has become a critical issue for industries to accurately record energy consumption, such as electricity usage and potential carbon emissions. Furthermore, the generation of Environmental, Social, and Governance (ESG) sustainability reports is necessary to support compliance with these regulations.

Currently, the measurement of electricity consumption, carbon emissions, or other forms of energy consumption is primarily conducted by installing energy consumption measuring device on each piece of manufacturing equipment to monitor the energy usage during operation. However, for electricity usage, most factories and offices typically use a single electric meter, which makes it challenging to record the electricity consumption of individual smaller units in detail.

Furthermore, assessing whether manufacturing equipment efficiency declines due to aging typically requires additional investment in the installation of energy consumption measuring device, which can lead to increased operational costs.

### SUMMARY

Accordingly, this disclosure provides a method and system of predicting energy consumption and recommending method of installing energy consumption measuring device to address the aforementioned issues.

According to one or more embodiments of this disclosure, a method of predicting energy consumption, performed by a computing device, is provided. The method includes: obtaining a plurality of historical manufacturing data, wherein each of the plurality of historical manufacturing data comprises total energy consumption and a plurality of historical performance values corresponding to a plurality of manufacturing conditions, respectively, each of the plurality of manufacturing conditions comprises at least one of an equipment type and a product type, and each of the plurality of historical performance values indicates one of an equipment operation duration and a product quantity; training and generating a unit energy consumption prediction model using the plurality of historical manufacturing data; obtaining at least one piece of unit energy consumption of at least one of the manufacturing conditions using a plurality of default performance values corresponding to the plurality of manufacturing conditions and the unit energy consumption prediction model; and outputting the at least one piece of unit energy consumption.

According to one or more embodiments of this disclosure, a system for predicting energy consumption is provided. The system includes an input and output device and a computing device. The input and output device is configured to obtain a plurality of historical manufacturing data, wherein each of the plurality of historical manufacturing data comprises total energy consumption and a plurality of historical performance values corresponding to a plurality of manufacturing conditions, respectively, each of the plurality of manufacturing conditions comprises at least one of an equipment type and a product type, and each of the plurality of historical performance values indicates one of an equipment operation duration and a product quantity. The computing device is connected to the input and output device, and the computing device is configured to perform a plurality of steps. The steps include: obtaining a plurality of historical manufacturing data, wherein each of the plurality of historical manufacturing data includes a total energy consumption and a plurality of historical performance values corresponding to a plurality of manufacturing conditions, respectively, each of the plurality of manufacturing conditions includes at least one of an equipment type and a product type, and each of the plurality of historical performance values indicates one of an equipment operation duration and a product quantity; training and generating a unit energy consumption prediction model using the plurality of historical manufacturing data; obtaining at least one piece of unit energy consumption of at least one of the manufacturing conditions using a plurality of default performance values corresponding to the plurality of manufacturing conditions and the unit energy consumption prediction model; and outputting the at least one piece of unit energy consumption through the input and output device.

According to one or more embodiments of this disclosure, a recommending method of installing an energy consumption measuring device is provided. The method includes: measuring a plurality of pieces of measured energy consumption corresponding respectively to a plurality of pieces of manufacturing equipment using the energy consumption measuring device; obtaining a plurality of pieces of unit energy consumption corresponding respectively to the plurality of manufacturing conditions, wherein the plurality of manufacturing conditions corresponding respectively to the equipment type of the plurality of manufacturing equipment; obtaining a plurality of error values using the computing device by comparing the plurality of pieces of measured energy consumption with the plurality of pieces of unit energy consumption; and identifying the pieces of manufacturing equipment as a recommendation result using the computing device, wherein based on the plurality of error values, the pieces of equipment whose error values exceed a default error value is identified as the recommendation result.

In view of the above description, the method and system of predicting energy consumption according to one or more embodiments of the present disclosure may utilize the unit energy consumption prediction model to determine the energy consumption of manufacturing each product or operating each piece of equipment without the need to install energy consumption measuring device on every piece of equipment, thereby reducing the time and cost associated with energy consumption prediction. In addition, through the recommending method of installing energy consumption measuring device according to one or more embodiments of the present disclosure, a user may install the energy consumption measuring device on manufacturing equipment with higher prediction error between the predicted value and the measured energy consumption according to the recommendation result. Consequently, the recommending method of installing energy consumption measuring device may yield more accurate energy consumption measurements as compared to relying solely on the unit energy consumption prediction model. Furthermore, the recommending method of installing energy consumption measuring device may result in lower costs compared to the approach of exclusively using the energy consumption measuring device to monitor energy consumption.

### BRIEF DESCRIPTION OF THE DRAWINGS

The present disclosure will become more fully understood from the detailed description provided hereinbelow and the accompanying drawings which are provided by way of illustration only and are not to be construed as limiting of the present disclosure and wherein:

FIG. 1 is a block diagram illustrating a system of predicting energy consumption according to an embodiment of the present disclosure;

FIG. 2 is a flow chart illustrating a method of predicting energy consumption according to an embodiment of the present disclosure;

FIG. 3 is a flow chart illustrating a process for training and generating a unit energy consumption prediction model in the method of predicting energy consumption according to an embodiment of the present disclosure;

FIG. 4 is a flow chart illustrating a process for predicting unit energy consumption of a target manufacturing condition in the method of predicting energy consumption according to an embodiment of the present disclosure; and

FIG. 5 is a flow chart illustrating a process for a recommending method of installing energy consumption measuring device according to an embodiment of the present disclosure.

### DETAILED DESCRIPTION

In the following detailed description, for purposes of explanation, numerous specific details are set forth in order to provide a thorough understanding of the disclosed embodiments. According to the description, claims and the drawings disclosed in the specification, one skilled in the art may easily understand the concepts and features of the present invention. The following embodiments further illustrate various aspects of the present invention, but are not intended to limit its scope.

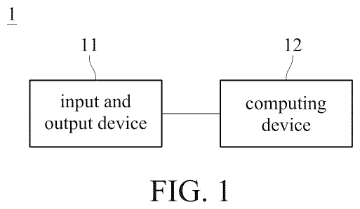

Please refer to FIG. 1, which is a block diagram illustrating a system of predicting energy consumption according to an embodiment of the present disclosure. As shown in FIG. 1, the system 1 of predicting energy consumption includes an input and output device 11 and a computing device 12. The input and output device 11 is electrically connected to or in communication connection with the computing device 12.

The input and output device 11 is configured to obtain a plurality of historical manufacturing data. The input and output device 11 may include an input element and an output element. The input element may include, but is not limited to, one or more of a keyboard, a mouse, and a communication module etc. The keyboard and the mouse are configured to allow a user to input a plurality of historical manufacturing data. The communication module may comprise a Wi-Fi module and/or a Bluetooth module. The communication module is configured to obtain the historical manufacturing data from another computing device (for example, a cloud server of a factory etc.).

The historical manufacturing data may correspond to different manufacturing timings, wherein the manufacturing timing may refer to a time point or a date. Each of historical manufacturing data includes total energy consumption and historical performance values corresponding respectively to different manufacturing conditions. Each of the manufacturing conditions includes at least one of an equipment type and a product type, and each of the historical performance values indicates one of an equipment operation duration and a product quantity. The total energy consumption represents the cumulative energy consumption corresponding to the manufacturing conditions, and may be obtained through energy consumption measuring devices disposed in a working environment of the manufacturing conditions. The energy consumption measuring device may include, but are not limited to, an electricity meter, a gas meter, a water meter, a greenhouse gas concentration sensor and a flow rate sensor that collectively measure the overall energy consumption in the working environment. The total energy consumption may include at least one of total electricity consumption, total gas consumption, total water consumption and total carbon emissions. The historical performance values corresponding respectively to the manufacturing conditions may be obtained from a manufacturing record, such as a manufacturing record from an enterprise resource planning (ERP) system. In addition, the historical manufacturing data may be generate into a format of an analytical base table (ABT) by a personal or an application software of an external computing device, after which the historical manufacturing data may be imported through the input and output device 11. Alternatively, the input and output device 11 may receive the total energy consumption and the manufacturing records and transmit the total energy consumption and the manufacturing records to the computing device 12. The computing device 12 may then generate the analytical base table according to a default format.

Please refer to table 1, table 2 and table 3 below, wherein table 1, table 2 and table 3 each exemplarily shows two historical manufacturing data entries, and table 1, table 2 and table 3 also exemplarily shows part of the manufacturing conditions and the total energy consumption corresponding to the manufacturing conditions. The number of historical manufacturing data entries and the number of the manufacturing conditions are not limited thereto.

TABLE 1

| | Total carbon | Faucet | Exhaust valve | Faucet seat |
|---|---|---|---|---|
| Date | emission (gram) | (piece) | (piece) | (piece) |
| 12/1 | 109941.7 | 59 | 67 | 60 |
| 12/2 | 144122 | 76 | 75 | 86 |

In table 1, the total energy consumption includes total carbon emissions, and the manufacturing conditions each includes the product type, such as, but not limited to, faucet, exhaust valve and faucet seat. The historical performance values indicate the product quantity of the corresponding product type.

TABLE 2

| | Total | | | |
|---|---|---|---|---|
| | electricity | | | |
| | consumption | Equipment 1 | Equipment 2 | Equipment 3 |
| Date | (kW) | (hour) | (hour) | (hour) |
| 12/1 | 197 | 16 | 20 | 22 |
| 12/2 | 734 | 5 | 1 | 0 |

In table 2, the total energy consumption includes total electricity consumption, and the manufacturing conditions each includes the equipment type, represented by equipment 1, equipment 2 and equipment 3, and the historical performance values indicate the equipment operation duration.

TABLE 3

| | | | Equipment | | Equipment |
|---|---|---|---|---|---|
| | | Equipment | 1 | Equipment | 2 |
| | | 1 | manu- | 2 | manu- |
| | Total | manu- | facturing | manu- | facturing |
| | electricity | facturing | exhaust | facturing | exhaust |
| | consumption | faucet | valve | faucet | valve |
| Date | (kW) | (hour) | (hour) | (hour) | (hour) |
| 12/1 | 8197 | 11 | 5 | 15 | 5 |
| 12/2 | 3734 | 3 | 2 | 1 | 0 |

In table 3, the total energy consumption includes total electricity consumption, and the manufacturing conditions each includes a combination of the product type and the equipment type. For example, equipment 1 is utilized to manufacture faucet, and the historical performance values indicate the equipment operation duration required for the equipment to manufacture the corresponding product.

The computing device 12 is configured to utilize the historical manufacturing data to predict unit energy consumption corresponding to at least one manufacturing condition. For example, referring to table 1, the unit energy consumption may include the total carbon emissions corresponding to the product quantity of one, such as the carbon emissions of manufacturing a single faucet. Referring to table 2, the unit energy consumption may include the total electricity consumption corresponding to the equipment operation duration of one hour, such as the electricity consumption of equipment 1 operating for one hour. Referring to table 3, the unit energy consumption may include the total electricity consumption corresponding to the equipment working for one hour to manufacture the product, such as the electricity consumption of equipment 1 functioning for one hour to manufacture faucet. The computing device 12 may include one or more processors, which may be, for example, a central processing unit (CPU), a graphics processing unit (GPU), a microcontroller, a programmable logic controller or any other processor with signal processing capabilities. The computing device 12 may further include one or more memory units configured to store the historical manufacturing data and a unit energy consumption prediction model. The memory may be a non-volatile memory (NVM), such as a read-only memory (ROM), a flash memory and/or a non-volatile random access memory (NVRAM), etc.

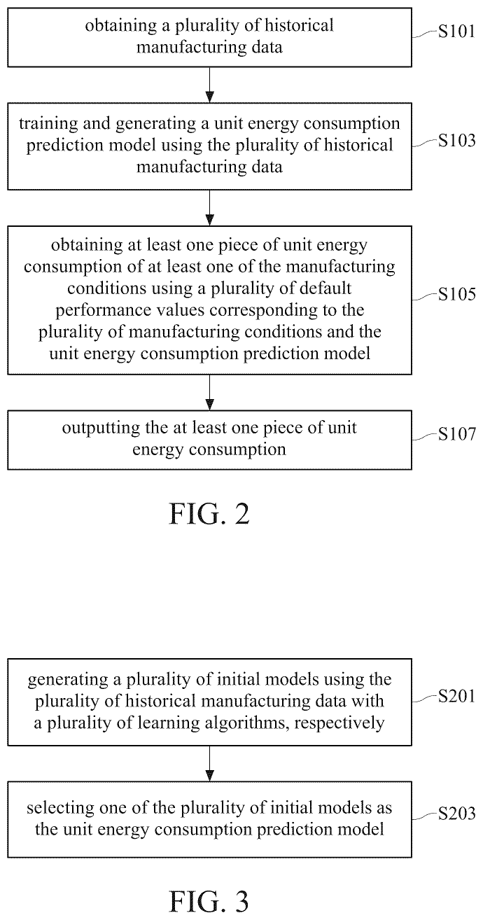

Please refer to FIG. 1 and FIG. 2, wherein FIG. 2 is a flow chart illustrating a method of predicting energy consumption according to an embodiment of the present disclosure. The method of predicting energy consumption shown in FIG. 2 may be performed by the computing device 12. As shown in FIG. 2, the method of predicting energy consumption includes: step S101: obtaining a plurality of historical manufacturing data; step S103: training and generating a unit energy consumption prediction model using the plurality of historical manufacturing data; step S105: obtaining at least one piece of unit energy consumption of at least one of the manufacturing conditions using a plurality of default performance values corresponding to the plurality of manufacturing conditions and the unit energy consumption prediction model; and step S107: outputting the at least one piece of unit energy consumption.

In step S101, the computing device 12 obtains the historical manufacturing data as described above from the input and output device 11.

In addition, in step S101, the computing device 12 may further use data cleaning function of automated machine learning (AutoML) software to eliminate abnormal data in the historical manufacturing data. The abnormal data may include the historical manufacturing data entries where the historical performance value is greater than a first abnormal threshold value and/or the total energy consumption is greater than a second abnormal threshold value. The first abnormal threshold value and the second abnormal threshold value are, for example but not limited to, standard deviations.

In step S103, the computing device 12 training and generating a unit energy consumption prediction model using the plurality of historical manufacturing data. The unit energy consumption prediction model may include, for example, a generalized linear model (GLM), a random forest model or an extreme gradient boosting (XGBoost) model, but the present disclosure is not limited thereto. Specifically, the computing device 12 may designate the total energy consumption as a prediction target (denoted as y) and utilize each manufacturing condition as an explanatory variable. For example, in the case of combining the equipment type and the product type, the explanatory variable may be denoted as m₁p₁, m₁p₂, . . . , m₁p_{q}, . . . , mₙp₁, mₙp_{q}, wherein m may represent the equipment type, p may represent the product type, and n and q are both positive integers greater than zero. The computing device 12 then imports sets of the corresponding historical performance values into AutoML software for training.

In step S105, the computing device 12 obtaining at least one piece of unit energy consumption of at least one of the manufacturing conditions using a plurality of default performance values corresponding to the plurality of manufacturing conditions and the unit energy consumption prediction model. Specifically, the computing device 12 may utilize the trial calculation function of the AutoML software to input the default performance values into the unit energy consumption prediction model to obtain the unit energy consumption. For example, referring to table 1, when the default performance values indicate the product quantities, the unit energy consumption may include carbon emissions associated with manufacturing one faucet, manufacturing one exhaust valve and/or manufacturing one faucet seat. Referring to table 2, when the default performance values indicate the equipment operation durations, the unit energy consumption may include electricity consumption of each one of equipment 1, equipment 2 and/or equipment 3 working for one hour. Take table 3 as an example, when the default performance values also indicate the equipment operation durations, the unit energy consumption may include electricity consumption of equipment 1 working for one hour to manufacture faucet, electricity consumption of equipment 1 operating for one hour to manufacture exhaust valve, electricity consumption of equipment 2 operating for one hour to manufacture faucet and/or electricity consumption of equipment 2 operating for one hour to manufacture exhaust valve.

In an embodiment of step S105, the computing device 12 may set the default performance value corresponding to the target condition as 1 and assign the default performance values corresponding to the other manufacturing conditions as 0 to obtain the unit energy consumption of the target condition. For example, when considering the combination of the equipment type and the product type as the manufacturing conditions, the computing device 12 may input equation (1) below to the unit energy consumption prediction model to obtain the unit energy consumption corresponding to the combination of equipment m₁ and product p₁. The calculation using either the product type or the equipment type as the manufacturing conditions follows the same principle, and details thereof are not repeated.

$$( {m}_{1} {p}_{1} , {m}_{1} {p}_{2} , … , {m}_{1} {p}_{q} , … , {m}_{n} {p}_{1} , {m}_{n} {p}_{q} ) = ( 1 , 0 , … , 0 , \text{…} , 0 , 0 ) \qquad Equation ( 1 )$$

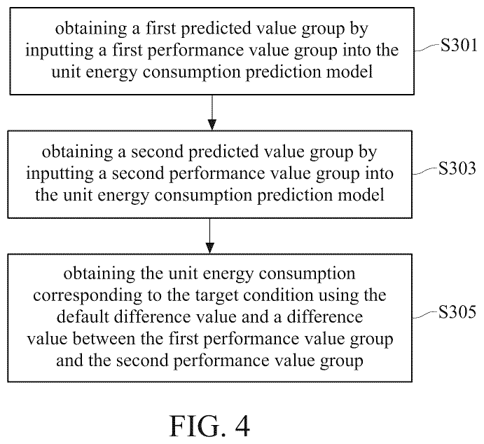

In another embodiment of step S105, the computing device 12 may utilize two sets of default performance values to obtain the unit energy consumption, the specific implementations are described along with FIG. 4 below.

In step S107, the computing device 12 outputs the unit energy consumption to a cloud system or a user interface, the present disclosure does not limit the subject or recipient of the output of the unit energy consumption.

Accordingly, the method and system of predicting energy consumption of above may use the unit energy consumption prediction model to determine the energy consumption of manufacturing each product or the operation of each equipment without installing energy consumption measuring device on every piece of equipment. This approach thereby reduces both the time and cost involved in energy consumption prediction.

In an embodiment, the unit energy consumption may include a plurality of pieces of unit energy consumption corresponding to the manufacturing conditions, respectively. The computing device 12 may further utilize the unit energy consumption and target performance values corresponding respectively to the manufacturing conditions to generate a predicted energy consumption value and output the predicted energy consumption value. Specifically, the computing device 12 may employ the trial calculation function of the AutoML software to perform the calculation of the predicted energy consumption value.

The target performance values may indicate the equipment operation duration, the product quantity or the equipment operation duration involved in the equipment to manufacture the corresponding product in the next manufacturing plan. The computing device 12 may utilize the unit energy consumption and the target performance value of each of the manufacturing conditions to generate and output the predicted energy consumption values. For example, when the target performance values represent the product quantities, the computing device 12 may multiply the product quantity of each product type by the corresponding unit energy consumption to calculate the total energy consumption (i.e., the predicted energy consumption value) required for manufacturing the product of each product type. The calculation of the equipment operation duration being the target performance value follows the same principle, and details thereof are not repeated. Furthermore, as described above, the computing device 12 may output the predicted energy consumption value to a cloud system or a user interface. The present disclosure does not limit the subject or recipient of the predicted energy consumption value.

Accordingly, the energy consumption required for manufacturing may be determined by inputting the equipment operation duration, the product quantity or the equipment operation duration required for the equipment to manufacture the corresponding product in the next manufacturing plan. Therefore, the disclosure eliminates the need to install a large number of energy consumption measuring devices for every products or piece of equipment. Instead, virtual energy consumption measurement technology may be utilized to allocate the required energy usage for production, allowing strategic adjustments to the factory's energy consumption based on the predicted results.

In an embodiment, the computing device 12 may further retrain and update the unit energy consumption prediction model using at least the plurality of historical manufacturing data when the at least one piece of unit energy consumption is less than zero. During the retraining process in step S103, the lower limit value of a model output value is set to zero. In other words, when the computing device 12 detects a negative unit energy consumption value, the computing device 12 may reexecute step S103 to update the unit energy consumption prediction model. During the reexecution step S103, the computing device 12 may configure the model function library to enforce a lower bound of zero for the model output value. Accordingly, both the predicted energy consumption value and the unit energy consumption output by the unit energy consumption prediction model will be ensure to be positive values.

Please refer to FIG. 1 and FIG. 3, wherein FIG. 3 is a flow chart illustrating the process of training and generating a unit energy consumption prediction model in the method of predicting energy consumption according to an embodiment of the present disclosure. FIG. 3 may be regarded as a detailed flowchart of an embodiment of step S103 of FIG. 2. As shown in FIG. 3, the training method may include: step S201: generating a plurality of initial models using the plurality of historical manufacturing data with a plurality of learning algorithms, respectively; and step S203: selecting one of the plurality of initial models as the unit energy consumption prediction model.

In step S201, the computing device 12 may utilize imported sets of historical manufacturing data to train models and apply various supervised learning algorithms from AutoML software to perform hyperparameter tuning on the models to obtain the initial models.

In step S203, the computing device 12 may select one of the initial models with optimal hyperparameter combination as the unit energy consumption prediction model. Further, the computing device 12 may select one of the initial models with a highest accuracy as the unit energy consumption prediction model. Specifically, the computing device 12 may compare the actual value measured by the energy consumption measuring device with the predicted values output by the initial models to determine model accuracy. Alternatively, the computing device 12 may determine error values by comparing the actual measured values with the predicted values to evaluate model accuracy, and select one of the initial models with highest model accuracy as the unit energy consumption prediction model.

In an embodiment, the model selection criterion may be based on the ratio of the actual measured value to the predicted value being closest to 1. In the other embodiment, the model selection criterion may be based on the error between the actual measured value and the predicted value being below a predefined threshold. In yet another embodiment, the model selection criterion may involve selecting the model with the lowest root-mean-square error (RMSE) between the actual measured value and the predicted value. The methods of model selection are not limited to these examples.

Please refer to FIG. 1 and FIG. 4, wherein FIG. 4 is a flow chart illustrating the process of predicting unit energy consumption of a target manufacturing condition with the method of predicting energy consumption according to an embodiment of the present disclosure. FIG. 4 may be regarded as a detailed flowchart of another embodiment of step S105 of FIG. 2. As shown in FIG. 4, the method of predicting the unit energy consumption of manufacturing the product may include: step S301: obtaining a first predicted value group by inputting a first performance value group into the unit energy consumption prediction model; step S303: obtaining a second predicted value group by inputting a second performance value group into the unit energy consumption prediction model; and step S305: obtaining the unit energy consumption corresponding to the target condition using the default difference value and a difference value between the first performance value group and the second performance value group. The present disclosure does not limit the sequence of performing step S301 and step S303, step S303 may be performed before step S301, or step S303 and step S301 may be performed concurrently.

In step S301, the computing device 12 may obtain a first predicted value group by inputting a first performance value group into the unit energy consumption prediction model. The first performance value group includes a first default performance value corresponding to the target condition among the manufacturing conditions. For example, if the manufacturing condition is defined by the combination of the equipment type and the product type, and target condition is the combination of equipment m₁ and product p₁, the computing device 12 may input the following equation (2) into the unit energy consumption prediction model to obtain the first predicted value group, wherein Q₁ is the first default performance value, and the value of r is the number of the manufacturing conditions.

$$( {m}_{1} {p}_{1} , {m}_{1} {p}_{2} , … , {m}_{1} {p}_{q} , … , {m}_{n} {p}_{1} , {m}_{n} {p}_{q} ) = ( {Q}_{1} , {Q}_{2} … , {Q}_{r} ) \qquad Equation ( 2 )$$

In step S303, the computing device 12 may obtain a second predicted value group by inputting a second performance value group into the unit energy consumption prediction model. The second performance value group includes the second default performance value corresponding to the target condition described above, and the second default performance value and the first default performance value has a default difference value therebetween. For example, if the manufacturing condition is defined by the combination of the equipment type and the product type, and the target condition is the combination of equipment m₁ and product p₁, the computing device 12 may input the following equation (3) into the unit energy consumption prediction model to obtain the second predicted value group, wherein the default difference value is a, and the default difference value may be 1, but the present disclosure is not limited thereto.

$$( {m}_{1} {p}_{1} , {m}_{1} {p}_{2} , … , {m}_{1} {p}_{q} , … , {m}_{n} {p}_{1} , {m}_{n} {p}_{q} ) = ( {Q}_{1} - α , {Q}_{2} … , {Q}_{r} ) \qquad Equation ( 3 )$$

In step S305, the computing device 12 may perform subtraction between the first predicted value group and the second predicted value group, and divide an absolute value of the difference value generated from the subtraction by the default difference value to obtain the unit energy consumption corresponding to the target condition.

In other words, in determining the unit energy consumption required for the combination of equipment m₁ and product p₁, the computing device 12 may subtract the default difference value (a) from the first default performance value in the first performance value group corresponding to the combination of equipment m₁ and product pt to generate the second performance value group, and respectively input the first performance value group and the second performance value group into the unit energy consumption prediction model to obtain the first predicted value group and the second predicted value group. The first predicted value group includes a first predicted value corresponding to the first default performance value (Q₁), and the second predicted value group includes a second predicted value corresponding to the second default performance value (Q₁−α). The computing device 12 may divide the difference value between the first predicted value and the second predicted value by the default difference value to determine the unit energy consumption required for the combination of equipment m₁ and product p₁.

It should be noted that the aforementioned method utilizes the value obtained by subtracting the default difference value from the first default performance value as the second default performance value. However, the second default performance value may also be a sum of the first default performance value and the default difference value. In addition, the calculation of using the product type or the equipment type as the target condition follows the same principle. Further details regarding calculation are not repeated herein.

In addition, one of the first default performance value and the second default performance value may be equal to an average value of the historical performance values in the historical manufacturing data corresponding to the target condition. For example, the computing device 12 may use an average value of the historical data for a specific product type, such as the faucet, in all historical manufacturing data of table 1 as the first default performance value or the second default performance value. Since the average value of the historical performance values is closely aligned the historical manufacturing data used for training the unit energy consumption prediction model, using the average value as the first default performance value or the second default performance value may result in more accurate predicted values, compared to setting the default performance value of the target condition as 1. This enables the calculation of more accurate unit energy consumption. Furthermore, in addition to the target condition, the performance values Q₂ to Qᵣ corresponding to other manufacturing conditions of the first performance value group and the second performance value group may also be set as the average values of the corresponding historical performance values.

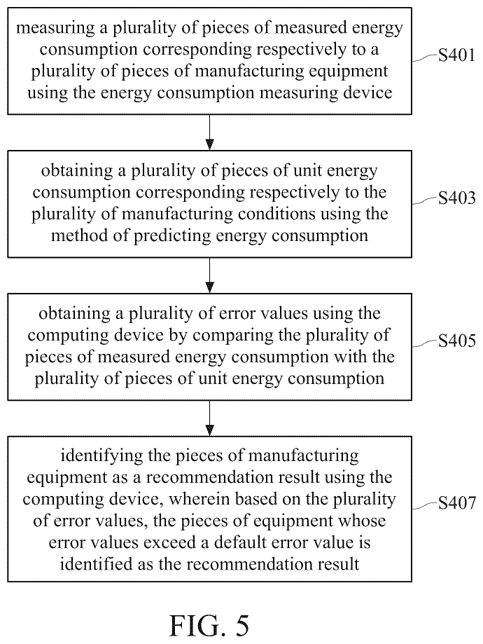

Please refer to FIG. 1 and FIG. 5, wherein FIG. 5 is a flow chart illustrating a recommending method of installing energy consumption measuring device according to an embodiment of the present disclosure. As shown in FIG. 5, the recommending method of installing energy consumption measuring device includes: step S401: measuring a plurality of pieces of measured energy consumption corresponding respectively to a plurality of pieces of manufacturing equipment using the energy consumption measuring device; step S403: obtaining a plurality of pieces of unit energy consumption corresponding respectively to the plurality of manufacturing conditions using the method of predicting energy consumption; step S405: obtaining a plurality of error values using the computing device by comparing the plurality of pieces of measured energy consumption with the plurality of pieces of unit energy consumption; and step S407: identifying the pieces of manufacturing equipment as a recommendation result using the computing device, wherein based on the plurality of error values, the pieces of equipment whose error values exceed a default error value is identified as the recommendation result. The present disclosure does not limit the sequence of performing S403 and S401. S403 may be performed before S401, or both steps may be performed concurrently. Although FIG. 5 illustrates S405 being performed after S401 and S403, the sequence shown in FIG. 5 is not intended to limit S405 to only being performed after the measured energy consumption of all manufacturing equipment using the energy consumption measuring device, and after using the method of predicting energy consumption to obtain the unit energy consumption of all manufacturing conditions. For example, once the measured energy consumption and the unit energy consumption of equipment 1 are obtained, the comparison between the measured energy consumption and the unit energy consumption may be performed.

The recommending method of installing energy consumption measuring device above may be performed by using the system 1 of predicting energy consumption of FIG. 1 along with the energy consumption measuring device. In step S401, the energy consumption measuring device is installed on each pieces of manufacturing equipment to obtain the measured energy consumption for each pieces of manufacturing equipment. The computing device 12 may receive the measured energy consumption, which is obtained by the energy consumption measuring device, through the input and output device 11. Furthermore, the computing device 12 may divide each of the measured energy consumption by the corresponding equipment operation duration, with the resulting values used as the measured energy consumption of the following steps.

In step S403, the computing device 12 obtain a plurality of pieces of unit energy consumption corresponding respectively to the plurality of manufacturing conditions using the method of predicting energy consumption. The manufacturing conditions indicate the types of the manufacturing equipment, respectively. In other words, the computing device 12 uses the method of predicting energy consumption to obtain the unit energy consumption corresponding to each of the pieces of manufacturing equipment.

In step S405, the computing device 12 obtain a plurality of error values using the computing device by comparing the plurality of pieces of measured energy consumption with the plurality of pieces of unit energy consumption. That is, the error values represent the differences between the actual energy consumption obtained by using the energy consumption measuring device to perform measurement and the energy consumption obtained by using the unit energy consumption prediction model. Furthermore, the computing device 12 may subtract the unit energy consumption from the measured energy consumption, and use absolute values of the difference values obtained from the subtraction as the error values.

In step S407, the computing device 12 uses one or more of the pieces of manufacturing equipment whose error value(s) exceed the default error value as the recommendation result. The recommendation result may indicate the identification data of the manufacturing equipment with an error value higher than the default error value. The default error value may be, for example, 5% or 10%, and may be set according to requirements; however the present disclosure is not limited thereto. The identification data may include one or more of a name, a serial number and a location in the factory corresponding to the manufacturing equipment. In an embodiment, the recommendation result may at least indicate the identification data of the manufacturing equipment with the highest error value. Furthermore, the recommendation result may indicate the identification data for multiple pieces of manufacturing equipment ranked according to their respective error values, wherein the rankings may be set according to actual requirements.

Accordingly, the user may install the energy consumption measuring device on the manufacturing equipment with higher prediction error according to the recommendation result. Therefore, the recommending method of installing energy consumption measuring device may provide more accurate energy consumption data comparing to performing prediction solely using the unit energy consumption prediction model. Furthermore, the recommending method of installing energy consumption measuring device may result in lower cost compared to measuring energy consumption entirely through the use of energy consumption measuring devices.

In an embodiment, the computing device 12 may select multiple pieces of equipment from a plurality of pieces of candidate equipment as the plurality of pieces of manufacturing equipment in step S401, wherein each selected pieces of equipment has a corresponding product type quantity exceeds a default value. The default value may be set by a personnel according to actual requirements. The candidate equipment may encompass all of the available manufacturing equipment, and the computing device 12 may prioritize the selection of equipment that is capable of manufacturing the most diversified range of products for use in performing step S401. Consequently, this approach eliminates the need for the energy consumption measuring device to be installed alternately on each piece of manufacturing equipment, thereby minimizing the time required to ascertain which manufacturing equipment should have the energy consumption measuring device installed and subsequently reducing the time needed to generate the aforementioned recommendation result.

In one or more embodiments above, the computing device may further compare the measured energy consumption obtained from using the energy consumption measuring device with the predicted energy consumption value (or the unit energy consumption) generated by the unit energy consumption prediction model. The computing device may output a warning notification to a cloud server or a user interface when the comparison result indicates that the difference between the measured energy consumption and the predicted energy consumption value (or the unit energy consumption) exceeds a predetermined warning threshold. This facilitates real-time anomaly detection. The warning threshold may be established by a personnel according to actual requirements.

In view of the above description, the method and system of predicting energy consumption according to one or more embodiments of the present disclosure utilize the unit energy consumption prediction model to ascertain the energy consumption associate with manufacturing each product or each equipment operation without necessitating the installation of energy consumption measuring device on each equipment, thereby reducing the time and cost required for energy consumption prediction. The method and system of predicting energy consumption according to one or more embodiments of the present disclosure may be used to obtain the energy consumption required for manufacturing by inputting the equipment operation duration, the product quantity or the equipment operation duration required for the equipment to manufacture the corresponding product in the next manufacturing plan. Therefore, it eliminates the need to install a large number of energy consumption measuring devices for all products or equipment. Instead, virtual energy consumption measuring technology may be employed to break down or analyze the energy usage required for manufacturing, allowing strategic adjustments to the factory's energy consumption based on the predicted results. Furthermore, by setting the lower limit value of the model output value to zero and conducting retraining, the predicted energy consumption value and the unit energy consumption output generated by the unit energy consumption prediction model can be ensured to be positive values. The utilization of the average value of the historical performance values as one of default performance values of the unit energy consumption enhances the accuracy of the obtained predicted values, leading to more reliable estimates of unit energy consumption. In addition, through the recommending method of installing energy consumption measuring device, as described in one or more embodiments of the present disclosure, the user may strategically install the energy consumption measuring device on the manufacturing equipment exhibiting higher prediction error between the predicted value and the measured energy consumption, as indicated by the recommendation result. Therefore, the recommending method of installing energy consumption measuring device yield more accurate energy consumption estimates compared to relying solely on the unit energy consumption prediction model. Furthermore, it incurs lower cost compared to entirely using the energy consumption measuring device to measure energy consumption. Lastly, by selecting the candidate equipment the product type quantity exceeding a predetermined threshold to evaluate suitability for energy consumption measuring device installation, it eliminates the need to install measuring devices on each piece of manufacturing equipment, thereby reducing the time required to identify the appropriate manufacturing equipment to install the energy consumption measuring device.

What is claimed is:

1. A method of predicting energy consumption, performed by a computing device, comprising:
obtaining a plurality of historical manufacturing data, wherein each of the plurality of historical manufacturing data includes a total energy consumption and a plurality of historical performance values corresponding to a plurality of manufacturing conditions, respectively, each of the plurality of manufacturing conditions includes at least one of an equipment type and a product type, and each of the plurality of historical performance values indicates one of an equipment operation duration and a product quantity;
training and generating a unit energy consumption prediction model using the plurality of historical manufacturing data;
obtaining at least one piece of unit energy consumption of at least one of the manufacturing conditions using a plurality of default performance values corresponding to the plurality of manufacturing conditions and the unit energy consumption prediction model; and
outputting the at least one piece of unit energy consumption.

2. The method of predicting energy consumption according to claim 1, wherein the at least one piece of unit energy consumption includes a plurality of pieces of unit energy consumption corresponding respectively to the plurality of manufacturing conditions, and the method of predicting energy consumption further comprises:
generating a predicted energy consumption value using the pieces of unit energy consumption and a plurality of target performance values corresponding respectively to the plurality of manufacturing conditions; and
outputting the predicted energy consumption value.

3. The method of predicting energy consumption according to claim 1, wherein obtaining the at least one piece of unit energy consumption of the at least one of the plurality of manufacturing conditions using the plurality of default performance values corresponding respectively to the plurality of manufacturing conditions and the unit energy consumption prediction model to comprises:
obtaining a first predicted value group by inputting a first performance value group into the unit energy consumption prediction model, wherein the first performance value group comprises a first default performance value corresponding to a target condition among the plurality of manufacturing conditions;
obtaining a second predicted value group by inputting a second performance value group into the unit energy consumption prediction model, wherein the second performance value group comprises a second default performance value corresponding to the target condition, and the second default performance value and the first default performance value have a default difference value therebetween; and
obtaining the unit energy consumption corresponding to the target condition using the default difference value and a difference value between the first performance value group and the second performance value group.

4. The method of predicting energy consumption according to claim 3, wherein one of the first default performance value and the second default performance value is equal to an average value of a plurality of historical performance values among the plurality of historical manufacturing data corresponding to the target condition.

5. The method of predicting energy consumption according to claim 1, wherein training and generating the unit energy consumption prediction model using the plurality of historical manufacturing data comprises:
generating a plurality of initial models using the plurality of historical manufacturing data with a plurality of learning algorithms, respectively; and
selecting one of the plurality of initial models as the unit energy consumption prediction model.

6. The method of predicting energy consumption according to claim 1, further comprising:
retraining and updating the unit energy consumption prediction model using at least the plurality of historical manufacturing data when the at least one piece of unit energy consumption is less than zero,
wherein a lower limit value of the model is set to zero during the retraining.

7. A recommending method of installing an energy consumption measuring device, comprising:
measuring a plurality of pieces of measured energy consumption corresponding respectively to a plurality of pieces of manufacturing equipment using the energy consumption measuring device;
obtaining a plurality of pieces of unit energy consumption corresponding respectively to the plurality of manufacturing conditions using the method of predicting energy consumption according to claim 1, wherein the plurality of manufacturing conditions corresponding respectively to the equipment type of the plurality of manufacturing equipment;
obtaining a plurality of error values using the computing device by comparing the plurality of pieces of measured energy consumption with the plurality of pieces of unit energy consumption; and
identifying the pieces of manufacturing equipment as a recommendation result using the computing device, wherein based on the plurality of error values, the pieces of equipment whose error values exceed a default error value is identified as the recommendation result.

8. The recommending method of installing energy consumption measuring device according to claim 7, further comprising:
selecting multiple ones from a plurality of pieces of candidate equipment with a corresponding quantity of product type exceeding a default value as the plurality of pieces of manufacturing equipment.

9. A system of predicting energy consumption, comprising:
an input and output device configured to obtain a plurality of historical manufacturing data, wherein each of the plurality of historical manufacturing data includes total energy consumption and a plurality of historical performance values corresponding to a plurality of manufacturing conditions, respectively, each of the plurality of manufacturing conditions includes at least one of an equipment type and a product type, and each of the plurality of historical performance values indicates one of an equipment operation duration and a product quantity; and
a computing device connected to the input and output device, the computing device configured to perform a plurality of steps, and the steps comprising:
training and generating a unit energy consumption prediction model using the plurality of historical manufacturing data;
obtaining at least one piece of unit energy consumption of at least one of the manufacturing conditions using a plurality of default performance values corresponding to the plurality of manufacturing conditions and the unit energy consumption prediction model; and
outputting the at least one piece of unit energy consumption.

10. The system of predicting energy consumption according to claim 9, wherein the at least one piece of unit energy consumption comprises a plurality of pieces of unit energy consumption corresponding respectively to the plurality of manufacturing conditions, and the computing device is configured to generate a predicted energy consumption value using the pieces of unit energy consumption and a plurality of target performance values corresponding to the plurality of manufacturing conditions, and output the predicted energy consumption value through the input and output device.

11. The system of predicting energy consumption according to claim 9, wherein the computing device is configured to:
obtaining a first predicted value group by inputting a first performance value group into the unit energy consumption prediction model, wherein the first performance value group comprises a first default performance value corresponding to a target condition among the plurality of manufacturing conditions;
obtaining a second predicted value group by inputting a second performance value group into the unit energy consumption prediction model, wherein the second performance value group comprises a second default performance value corresponding to the target condition, and the second default performance value and the first default performance value have a default difference value therebetween; and
obtaining the unit energy consumption corresponding to the target condition using the default difference value and a difference value between the first performance value group and the second performance value group.

12. The system of predicting energy consumption according to claim 11, wherein one of the first default performance value and the second default performance value is equal to an average value of a plurality of historical performance values among the plurality of historical manufacturing data corresponding to the target condition.

13. The system of predicting energy consumption according to claim 9, wherein the computing device is configured to generate a plurality of initial models using the plurality of historical manufacturing data with a plurality of learning algorithms, respectively, and select one of the plurality of initial models as the unit energy consumption prediction model.

14. The system of predicting energy consumption according to claim 9, wherein the computing device is further configured to retrain and update the unit energy consumption prediction model using at least the plurality of historical manufacturing data when the at least one piece of unit energy consumption is less than zero, wherein a lower limit value of the model is set to zero during the retraining.
